(19) United States
(12) Patent Application Publication
(10) Pub. No.: US 2014/0346121 A1
(43) Pub. Date: Nov. 27, 2014

(54) Method for Treatment of Sulphide-Containing Spent Caustic

(71) Applicant: Ultrasonic Systems GmbH, Thierhaupten (DE)

(72) Inventors: Ulrich Poeschl, Buttenwiesen (DE); Carmelo Oliveri, Ulm (DE)

(21) Appl. No.: 14/366,683

(22) PCT Filed: Dec. 18, 2012
(86) PCT No.: PCT/EP2012/005253

§ 371 Date: Jun. 19, 2014

(30) Foreign Application Priority Data
Dec. 21, 2011 (DE) 10 2011 121 910.6

(51) Int. Cl. C02F 1/36; C02F 1/00; C02F 1/78

(52) U.S. Cl. CPC C02F 1/36; C02F 1/78; C02F 1/008; C02F 2101/101
USPC 210/742; 210/748.04; 210/149

(57) ABSTRACT

The invention relates to a method for treatment of a sulphide-containing spent caustic via chemical conversion of the sulphides, wherein the method is comprised of the following steps:
introducing the spent caustic into a reaction chamber (18) that is comprised of at least one acoustic power converter (22) and one cavitation element (20),
treating the spent caustic with ultrasound from the at least one acoustic power converter (22),
feeding a gas mixture containing ozone into the reaction chamber and distributing the gas mixture containing ozone in the spent caustic using the cavitation element (20),
wherein the sulphide-containing spent caustic is converted with the gas mixture containing ozone, forming non-sulphide-bearing, inorganic sulphur compounds.

### CROSS REFERENCE TO RELATED APPLICATIONS

This application is the U.S. national stage of International Application No. PCT/EP2012/005253 filed on Dec. 18, 2012, and claims the benefit thereof. The international application claims the benefit of German Application No. DE 102011121910.6 filed on Dec. 21, 2011; all applications are incorporated by reference herein in their entirety.

### BACKGROUND

The invention relates to a method for treatment of a sulphide-containing spent caustic via chemical conversion of the sulphides, especially via oxidation.

Alkaline waste water and process water containing sulphides, also called “spent caustics” below, arise in a number of industrial processes. Alkaline spent caustics are customarily used to wash out acidic components from various gas flows or for extraction from spent caustic flows. The gas flows are created in the petrochemical industry, petroleum refining, pulp and paper production and various chemical manufacturing processes. The acidic components include hydrogen sulphide, H₂S, mercaptans, RSH and possibly carbon dioxide and other organic acids. In addition, the sulphide-containing spent caustics can also contain other organic substances that add to the chemical oxygen demand (COD) of the lye. The organic substances include, in particular, phenols, organic acids and oils.

The contaminated sulphide-containing spent caustics present a substantial disposal problem both because of their alkali content and because of the acidic components contained in them, especially the sulphides. The neutralization of the sulphide-containing spent caustics via the addition of acid leads to a release of toxic hydrogen sulphide. It is therefore necessary to convert the acidic components contained in the spent caustics into a form suitable for release into the environment.

Various methods are known for treating sulphide-containing spent caustics. DE 196 12 945 A1 describes the chemical conversion of sulphides with sulphur dioxide and the formation of thiosulphate at a pH value of around 6. Both sulphur dioxide and thiosulphate are not toxicologically harmless, however. Moreover, the required acidification of the spent caustic leads to a substantial amount of salts that also have to be disposed of.

A method for treating sulphide-containing spent caustics via wet oxidation is known from U.S. Pat. No. 4,350,599. The acidic components of the spent caustic are converted into inorganic sulphate, carbon dioxide and water via oxidation with atmospheric oxygen at an increased temperature and at an increased pressure in this process. The oxidation takes place in a closed system, so an escape of the harmful substances into the atmosphere is prevented for the most part. The high alkalinity of the sulphide-containing spent caustics necessitates the use of special construction materials, though, for instance corrosion-resistant nickel steel that can withstand the pressure and temperature conditions prevailing during the execution of the wet oxidation. These methods are therefore very expensive.

A device for treating a spent caustic with a mechanical cavitation element arranged in a chamber and a gas supply system that extends through the cavitation element is known from WO 2008/080618 A1. The device also includes an acoustic power converter that radiates sound waves directly into the chamber. The movements of the cavitation element provide for a mixture of the gas that is supplied with the spent caustic to be treated. As a second measure, sound waves are directly transmitted into the spent caustic with the aid of the acoustic power converter; the average bubble size is reduced in the overall spent caustic because of that. The power converter is designed, in particular, to be an ultrasonic generator that provides frequencies in a range between 400 and 1500 kHz, preferably between 600 and 1200 kHz. It is suggested that the device be used to sterilize waste water via treatment with ozone.

### SUMMARY

The invention relates to a method for treatment of a sulphide-containing spent caustic via chemical conversion of the sulphides, wherein the method is comprised of the following steps:

introducing the spent caustic into a reaction chamber (18) that is comprised of at least one acoustic power converter (22) and one cavitation element (20),

treating the spent caustic with ultrasound from the at least one acoustic power converter (22),

feeding a gas mixture containing ozone into the reaction chamber and distributing the gas mixture containing ozone in the spent caustic using the cavitation element (20),

wherein the sulphide-containing spent caustic is converted with the gas mixture containing ozone, forming non-sulphide-bearing, inorganic sulphur compounds.

### DETAILED DESCRIPTION

The invention is based on the problem of providing a cost-effective method for treating sulphide-containing spent caustics with which some of the drawbacks of the methods known in the prior art can be avoided.

To solve this problem, a method for treating a sulphide-containing spent caustic via the chemical conversion of the sulphides will be provided as per the invention; the method includes the following steps:

Introducing the spent caustic into a reaction chamber that is comprised of at least one acoustic power converter and one cavitation element,

treating the spent caustic with ultrasound from the at least one acoustic power converter,

feeding a gas mixture containing ozone into the reaction chamber and distributing the gas mixture containing ozone in the spent caustic using the cavitation element,

wherein the sulphide-containing spent caustic is converted with the gas mixture containing ozone, forming non-sulphide-bearing, inorganic sulphur compounds.

The method as per the invention distinguishes itself by the fact that the treatment of the sulphide-containing spent caustic can be carried out under ambient conditions. There are therefore fewer requirements on the corrosion resistance of the device used to carry out the process and the connected pipelines. In addition, no pressure-resistant or heat-resistant apparatus has to be provided. Since the conversion of the sulphide-containing spent caustic via oxidation with ozone is an exothermic process, the method can be controlled by monitoring the temperature of the spent caustic. That makes it possible for the process to be carried out in a simple way.

The spent caustic will preferably have a pH value of around 8 to 14 with a special preference for a pH value of 9 to 12. All of the hydrogen sulphide is in the form of sulphide ions at these pH values, so there is no risk of a release of toxic hydrogen sulphide into the environment.

The ultrasonic treatment is preferably performed in a frequency range of 400 to 1500 kHz and from 600 to 1200 kHz as a preference. No acceleration worth mentioning of the oxidation reaction between the sulphide and the ozone is expected below 400 kHz. Ultrasonic generators with a frequency band of over 1500 kHz do not show any improvement in performance.

The ultrasonic treatment of the sulphide-containing spent caustic can take place before, during and/or after the addition of the gas mixture containing ozone into the reaction chamber.

In accordance with a special embodiment, the sulphide-containing spent caustic is already treated with ultrasound before the addition of the gas mixture containing ozone into the reaction chamber. Without wanting to be bound to a theory, it is assumed that the sulphide-containing spent caustic will be loaded with energy via the ultrasonic treatment and OH radicals will be formed that foster the subsequent conversion of the sulphides with ozone.

The ultrasonic treatment during and/or after the introduction of the gas mixture containing ozone into the spent caustic brings about a breakdown into extremely small portions of the gas bubbles brought into the spent caustic via the cavitation element and can lead to a molecularly disperse solution of the gas mixture.

An ultrasonic treatment both before and during and/or after the feeding of the gas mixture containing ozone into the reaction chamber is especially preferred; there is an even better distribution or molecularly disperse solution of the gas mixture in the sulphide-containing spent caustic because of that. Because of the high proportion of dissolved gas in the sulphide-containing spent caustic, it is assumed that not only the ozone contained in the gas mixture, but also the dissolved oxygen will make a contribution towards oxidation of the sulphides and optionally the other organic substances with the formation of non-sulphide-bearing, inorganic sulphur compounds, especially sulphate, and carbon dioxide.

The sulphides are preferably converted with ozone at around 20 to 40° C. Consequently, the process can essentially be carried out at room temperature. The exothermic conversion of the sulphides with ozone or oxygen leads to a rise in temperature in the sulphide-containing spent caustic that can be used to control the reaction.

In accordance with an especially preferred embodiment of the process as per the invention, temperature sensors are therefore provided at the reaction chamber and/or in the supply or discharge lines; the temperature values that are measured can be evaluated in a control device. The amount of ozone to be fed into the reaction chamber can then be calculated with this evaluation.

The process is preferably carried out in such a way that the entire amount of ozone that is fed into the reaction chamber is consumed. Subsequent treatment of the gases discharged from the device is therefore not necessary.

There are provisions for safety reasons, though, for the gases that are discharged from the device to be passed through a catalytic converter to break down residual ozone and/or a catalytic converter to further oxidize compounds containing sulphur, especially hydrogen sulphide and/or sulphur dioxide.

In accordance with a further embodiment of the invention, several successive reaction chambers can be provided in which the ultrasonic treatment and the conversion of the spent caustic with ozone can be carried out in each case. The amount of time required to remove the sulphides from the spent caustic down to a set concentration value can be substantially reduced with that.

As a special preference, the process as per the invention is carried out at the ambient pressure. The reaction chamber and the other pipelines of the device are therefore not required to be designed in a pressure-resistant way.

Moreover, the process as per the invention permits a modular design of the device, so reaction chambers that have already been prefabricated can be joined to one another as desired and connected to the feeder tank that contains the sulphide-containing spent caustic. The process can consequently be carried out on site in mobile stations. Transport of the sulphide-containing spent caustic is therefore unnecessary.

The fundamental structure of the reaction chamber with the mechanical cavitation element and a device for supplying gas containing ozone is basically known from WO 2008/080618 A1, to which reference is made.

The mechanical cavitation element is preferably a rotating flow guide structured in such a way that it creates zones with the highest possible flow velocity along its surface, in order to attain the greatest possible cavitation effect and therefore a good mixing of the gas mixture with the spent caustic.

The mechanical cavitation element is designed in the form of a disc or discoid, for instance. In so doing, a disk can be used that is supplied with special structures, for instance ellipsoidal packets, with very high flow velocities developing in their proximity.

The gas mixture containing ozone is preferably supplied by means of a gas supply line directly on the surface of the cavitation element. The gas mixture can be virtually completely input into the spent caustic because of that. The gas mixture containing ozone is fed in as a special preference in the area of the greatest flow velocity at the surface of the cavitation element, because an especially good mixture can be obtained in that way. That can be done in the proximity of the above-mentioned structures or in the proximity of the edge of the disc.

The acoustic power converter is preferably a piezoelectric element that can be designed in the form of a disc, for example.

It is possible to arrange only one, two or a multitude of acoustic power converters in the reaction chamber. Each of the acoustic power converters preferably has direct contact with the spent caustic, so the sound waves are directly emitted into the spent caustic. In this context, direct contact means that no conducting solids of the power converter introduce the vibrations into the spent caustic, as a sonotrode does, for instance. Rather, the spent caustic in this embodiment is directly at the power converter, and thus the ultrasound source itself.

The acoustic power converter is operated in a pulsed fashion in an advantageous embodiment of the invention. This pulse duration is chosen in such a way here that the gas bubbles break down into extremely small portions and the gas mixture containing ozone is dissolved in the spent caustic in the most effective way possible. If several acoustic power converters are provided, all of them or only a few of them can be operated in a pulsed fashion with the same or different pulse durations and pulse frequencies.

The reaction chamber is preferably completely filled with spent caustic when the spent caustic is introduced, so the sound waves propagate in the entire reaction chamber and can be reflected back into the spent caustic from all directions. The gas quantity that is introduced and the gas flow rate are preferably chosen in such a way that no gas volume arises over the spent caustic.

In an advantageous embodiment of the process as per the invention, the spent caustic flows through the reaction chamber during the treatment with ultrasound and the cavitation treatment. The process is therefore not applied to a standing volume of spent caustic, but is instead applied to the spent caustic flowing through the reaction chamber according to the flow-through principle.

For the purposes of this description, the term “reaction chamber” essentially constitutes the contiguous volume around the cavitation element to the volume around the acoustic power converter(s). These volumes can be in direct proximity to one another or be spaced apart from one another; the spacing between the volumes is also determined by the outgassing of the gas mixture introduced into the spent caustic with the aid of the cavitation element.

The reaction chamber can be made up of a single chamber in which both the cavitation element and the acoustic power converter(s) are arranged, or can be made up of several chambers that are continuously connected to one another via pipelines; the cavitation element and the acoustic power converter are arranged in their own chamber in each case. What is important in this case, however, is that the ultrasound has an effect right up to the cavitation element.

It is beneficial when the entire reaction chamber that includes the cavitation element and the acoustic power converter(s) is covered as evenly as possible by the sound waves of the acoustic power converter(s).

In addition, the invention relates to apparatus for carrying out the method as per the invention with a feeder tank for sulphide-containing spent caustic and a reaction chamber connected in terms of flow with the feeder tank, wherein the reaction chamber includes at least one acoustic power converter and a mechanical cavitation element and wherein a supply unit for gas containing ozone is provided in the reaction chamber, characterised in that the device further includes one or more temperature sensors and a control unit connected to the temperature sensor(s) and the supply unit for controlling the quantity of gas containing ozone that is supplied to the reaction chamber in dependence upon the temperature of the spent caustic.

The method as per the invention and the apparatus as per the invention are particularly suitable for treating sulphide-containing spent caustics from petrochemical refineries and plants in the area of pulp and paper production. The method is not limited to these applications, however. In particular, the use of the method for treating waste water from biogas plants is conceivable.

### BRIEF DESCRIPTION OF THE DRAWINGS

Further features and advantages of the invention follow from the description below and from the enclosed drawings, to which reference is made. The following are shown in the drawings:

FIG. 1 shows a schematic flow chart of the method as per the invention; and

FIGS. 2a and 2b show schematic sectional views of the reaction chamber of apparatus for carrying out the method as per the invention.

### DETAILED DESCRIPTION OF THE PREFERRED EMBODIMENT

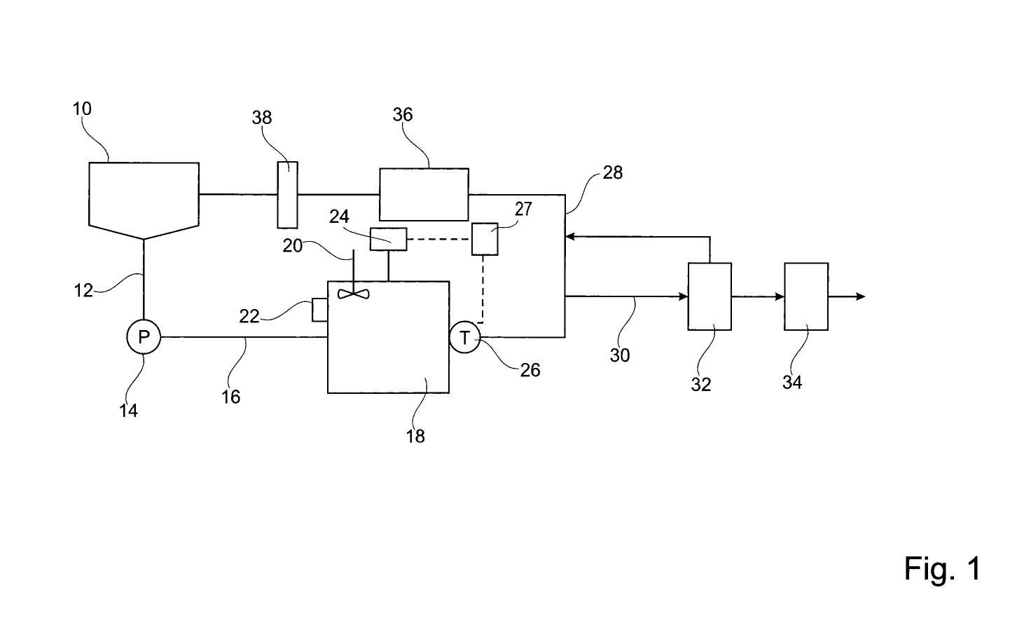

A flow chart of the method as per the invention for treating a sulphide-containing spent caustic is shown in FIG. 1. Raw, sulphide-containing spent caustic flows from a feeder tank 10 through a pipeline 12 to a pump 14, which brings the spent caustic into the treatment device. The raw caustic is conveyed by the pump through a pipeline 16 into the reaction chamber 18.

A mechanical cavitation element 20 is provided in the reaction chamber 18. Furthermore, the reaction chamber includes at least one acoustic power converter 22, in particular an ultrasonic generator. Moreover, an ozone generator 24, from which a gas mixture containing ozone is supplied to the reaction chamber, is connected to the reaction chamber 18. The gas mixture containing ozone can preferably be supplied from the ozone generator 24 to the reaction chamber 18 via the mechanical cavitation element 20. Furthermore, a temperature sensor 26 can be arranged on or in the reaction chamber 18 and/or in the supply lines or discharge lines.

The sulphide-containing spent caustic is fed into the reaction chamber 18 under ambient conditions, meaning at the ambient temperature and ambient pressure. The spent caustic is then treated in the reaction chamber 18 by introducing ultrasound from the acoustic power converter 22 at a frequency in the range of 400 to 1400 kHz while the spent caustic flows through the reaction chamber.

After that, or simultaneously with the ultrasonic treatment, a gas mixture containing ozone is introduced into the reaction chamber 18 from the ozone generator 24 and finely dispersed in the spent caustic with the mechanical cavitation element 20. As a preference, the gas mixture containing ozone is directly supplied through the rotating cavitation plate of the cavitation element 20 in the process.

The amount of ozone produced by the ozone generator is preferably at least approximately 80 g/h. Lower amounts of ozone prolong the amount of time required for the complete conversion of the sulphides. The precise amount of ozone can be determined by taking the amount of spent caustic to be treated and the maximum solubility of the ozone in the spent caustic into consideration.

The oxidation of the sulphides in the spent caustic via ozone and possibly oxygen, OH radicals and peroxo compounds that arise because of the input of ozone and/or the ultrasonic treatment in the spent caustic starts up almost immediately and leads to an increase in the temperature of the spent caustic, which can be determined with the temperature sensor 26.

The increase in the temperature determined by the temperature sensor 26 can be evaluated in a control unit 27 and used to control the amount of ozone that is produced with the ozone generator and supplied to the spent caustic. As a preference, ozone will only be generated and supplied to the spent caustic to the extent that the entire amount of ozone is consumed and converted with the sulphides and other oxidisable compounds in the spent caustic.

The spent caustic that is treated with ozone will be routed out of the reaction chamber through a pipeline 28 and passed back into the feeder tank 10. A discharge line 30 that can carry off excess gas from the treatment device is provided on the pipeline 28. Spent caustic or solids that are carried along by the gas can be condensed in a cooling device 32 and fed back into the pipeline 28.

In accordance with a preferred embodiment, the discharge line 30 for excess gas is provided at or in the proximity of the reaction chamber 18. Excess pressure in portions of the pipeline 28 an thereby be prevented.

The gas that is dried in the cooling device 32 can, moreover, be passed through one or more catalytic converters 34 to free the gas or residual ozone and/or sulphur-containing compounds before it is released into the atmosphere.

Furthermore, a cooling device 36, for instance a heat exchanger, can be provided in the pipeline 28 to keep the temperature of the spent caustic within predetermined limits. Additionally, the treated spent caustic can be liberated in a separation device 38 from solids that can form during the conversion of the sulphide-containing spent caustic. The separation device can be a gap filter, decanter or another type of filter.

The spent caustic from the feeder tank 10 is put through a cycle until the sulphide content has dropped to a fixed value, for instance 50 ppm or lower. It has turned out, in addition, that the feedback of the treated spent caustic into the cycle shortens the treatment period overall.

Alternatively or additionally, the chemical oxygen demand of the spent caustic can also be determined; both the sulphides and other organic substances that are likewise oxidized by ozone make a contribution to it.

The feeder tank 10 is emptied and is available to take in new raw caustic as soon as the target values for the sulphides and/or the chemical oxygen demand has been reached. The treated spent caustic can either be diluted, neutralized and/or fed into a sewage treatment plant.

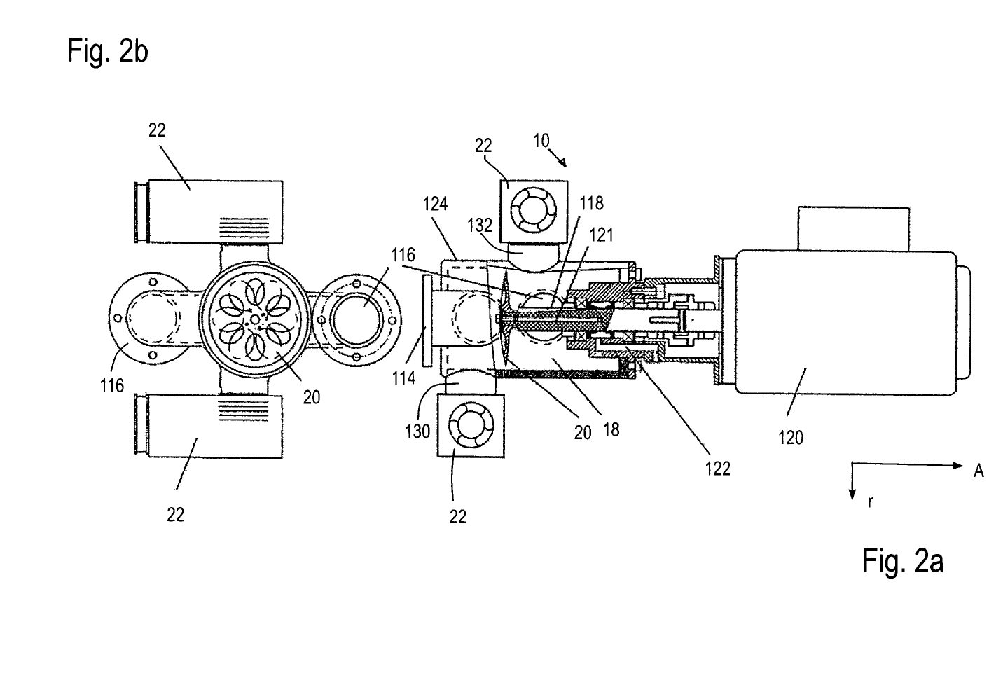

The reaction chamber 18 for taking in and chemically converting the spent caustic shown in the form of a schematic diagram in FIGS. 2a and 2b has an inlet 114 and an outlet 116. The reaction chamber 18 is designed in the form of a single chamber in this example.

The process is operated according to the flow-through principle, i.e. the spent caustic flows with a uniform flow velocity through the inlet 114 into the reaction chamber 18 and out of the reaction chamber 18 through the outlet 116. The inlet 114 and the outlet 116 are located in an offset vis-a-vis one another on opposite sides of the reaction chamber 18 in the axial direction A. In operation, the device is aligned in such a way that the inlet 114 is at the lower end of the reaction chamber 18.

The entire reaction chamber 18 is completely filled with spent caustic when the device is operated.

In close proximity to the inlet 114 there is a mechanical cavitation element 20 in the form of a horizontal and rotatable disk-shaped plate with a flow guide design and with opposing convex sides that meet at a sharp peripheral edge. The cavitation element 20 is connected via a hollow shaft 118 to a continuously controllable motor 120 that determines the rotary speed of the cavitation element 20. The cavitation element 20 is completely immersed in the spent caustic and is moved so quickly that cavitation arises in the spent caustic.

A gas supply line 121 is provided in the interior of the hollow shaft 118 that is part of a gas supply system; a gas mixture containing ozone from the ozone generator (not shown here) is routed through the gas supply line for introduction into the spent caustic at the surface of the cavitation element 20. The gas supply line 121 is connected to a channel 122 for this that ends outside of the reaction chamber 18 and that can be connected to the ozone generator (not shown).

The gas supply line 121 ends directly at the surface of the cavitation element 20 in the embodiment shown here. The gas mixture containing ozone consequently directly emerges at the surface of the cavitation element 20 and is introduced into the spent caustic in the area of the greatest cavitation effect.

The gas supply line is in direct proximity to the surface of the cavitation element 20, but it can also be placed elsewhere, not just through the cavitation element 20.

The reaction chamber 18 is surrounded by a wall 124 that keeps the spent caustic in the reaction chamber 18. In addition to the chamber in which the cavitation element 20 is located, the connecting pipelines are also part of the reaction chamber 18.

Furthermore, the reaction chamber 18 includes two short connecting pieces 130, 132, bent at an angle of 90°, to which an acoustic power converter 22 is connected in each case and that connect the acoustic power converters 22 to the chamber that contains the cavitation element 20. The two acoustic power converters 22 are preferably designed to be ultrasonic generators, and they operate in a frequency range of 400 to 1500 kHz, preferably in a frequency range of 600 to 1200 kHz. The connection piece 130 ends at the height of the inlet 114, offset from it by 90° in the direction of the circumference, whereas the connection piece 132 ends at the height of the outlet 116, likewise offset from it by 90°.

The acoustic power converters 22 couple and input the ultrasonic energy in the form of an elementary wave directly into the spent caustic and also into the cavitation element 20 and, in fact, on both sides of each disk-shaped power converter 22.

To load the spent caustic with the gas mixture containing ozone, the cavitation element 20 is made to rotate so quickly that cavitation comes about in the spent caustic. The gas containing ozone is routed to the surface of the cavitation element 20 by the gas supply system. Essentially all of the gas that is introduced is put into the spent caustic because of the cavitation effect.

Since the entire space is filled with the sound waves of the acoustic power converters 22, the bubbles created by the cavitation element 20 are immediately broken down into extremely small portions by the sonic energy; an average bubble size in the range of nanometres arises, and a large proportion of the bubbles are created in the angstrom range. This leads to a major portion of the gas mixture containing ozone that was introduced into the spent caustic being molecularly dispersed in the spent caustic. That is why all of the gas that is introduced remains in the spent caustic for a relatively long period of time.

In the arrangement that is shown, the first acoustic power converter 22 in terms of the flow can also be used for a sono-chemical pre-treatment of the spent caustic before it is loaded with the gas mixture containing ozone. The spent caustic that flows in is directly exposed to the sound waves of the acoustic power converter 22, which leads to the subsequent oxidation reaction being faster.

### EXAMPLE

8 litres of an alkaline wash water loaded with sulphide from a refinery was diluted with 500 litre of pure water and stored in a feeder tank. The sulphide-containing spent caustic that was obtained in that way had a pH value of 11.93, a chemical oxygen demand (COD) of 2364 mg/l and a sulphide content of 450 mg/l.

A device as per the invention in the form of a pilot plant with a reaction chamber 18, in which a mechanical cavitation element 20 and two acoustic power converters 22 designed as ultrasonic generators upstream and downstream of the cavitation element are provided, was connected to the feeder tank via a pump. Moreover, a commercially available ozone generator 24 (manufacturer Ozonia AG, Switzerland) was connected to the reaction chamber.

Around 200 g/h of ozone mixed with oxygen was introduced into the spent caustic with the aid of the ozone generator and treatment was provided in flow-through operation. The cavitation element was operated at around 3000 r.p.m. The ultrasonic generator provided a frequency of around 600 kHz with a power output of around 1400 watts.

The excess or converted gas (essentially air or oxygen) was discharged from the device through discharge lines; the liquid portions condensed from the gas were fed back into the device in the process.

The treated spent caustic was subsequently fed back into the feeder tank. The process was carried out in cycles until the sulphide content of the spent caustic had a stable value of less than 10 ppm. Samples were drawn from the feeder tank and analysed with regard to the sulphide content and the COD in intervals of time that were previously set. In so doing, the measured values shown in the following table resulted.

TABLE
Treatment of 8 litres of spent caustic in 500 litres of pure water:

| Time | | | T | COD | Sulphide |
|---|---|---|---|---|---|
| min. | Sample | pH | ° C. | mg/l | mg/l |
| 0 | Raw | 11.93 | 22.2 | 2364 | 450 |
| 15 | 1 | 11.91 | 23.6 | 2454 | 460 |
| 30 | 2 | 11.9 | 24.6 | | 300 |
| 45 | 3 | 11.78 | 26.2 | | 190 |
| 60 | 4 | 11.4 | 28.2 | 2043 | 160 |
| 75 | 5 | 11.42 | 25.2 | | 110 |
| 90 | 6 | 11.5 | 27.2 | | 19 |
| 105 | 7 | 11.42 | 25.8 | 1725 | 6 |
| 120 | 8 | 11.2 | 30.2 | | 5 |
| | 9 | 11.42 | 28.2 | | 11 |
| | 10 | 11.21 | 28.2 | | 10 |
| | 11 | 11.21 | 30.6 | 1515 | 7 |

The treatment of the sulphide-containing spent caustic using the method as per the invention already led to a reduction of the proportion of sulphide to less than the limit values after around 2 hours, which permits introduction into municipal or industrial waste water treatment plants. The method can be carried out with technically available means under ambient conditions, nearly ambient temperature and normal pressure. Since an arbitrary number of reaction chambers can be connected one after the other, the method can be applied in a flexible way and can easily be adapted to a customer's requirements and/or the quantity of spent caustic to be treated in a unit of time.

1. Method for treatment of a sulphide-containing spent caustic via chemical conversion of the sulphides, wherein the method is comprised of the following steps:
introducing the spent caustic into a reaction chamber that is comprised of at least one acoustic power converter and one cavitation element,
treating the spent caustic with ultrasound from the at least one acoustic power converter,
feeding a gas mixture containing ozone into the reaction chamber and distributing the gas mixture containing ozone in the spent caustic using the cavitation element,
wherein the sulphide-containing spent caustic is converted with the gas mixture containing ozone, forming non-sulphide-bearing, inorganic sulphur compounds.

2. Method according to claim 1, characterised in that a spent caustic with a pH value of between 8 and 14, preferably from 9 to 12, is used.

3. Method according to claim 1, characterised in that the ultrasonic treatment is carried out with 400 to 1500 kHz.

4. Method according to claim 1, characterised in that the sulphide-containing spent caustic is treated with ultrasound before the addition of the gas mixture containing ozone.

5. Method according to claim 1, characterised in that the gas mixture containing ozone is an oxygen/ozone mixture.

6. Method according to claim 1, characterised in that the sulphides are converted with ozone at 20 to 40° C.

7. Method according to claim 1, characterised in that the temperature of the sulphide-containing spent caustic is measured and evaluated to control the quantity of ozone to be supplied to the spent caustic.

8. Method according to claim 1, characterised in that the method is carried out in several reaction chambers arranged one behind the other.

9. Method according to claim 1, characterised in that the ultrasonic treatment and the conversion with ozone are carried out at the ambient pressure.

10. Method according to claim 1, characterised in that the gas mixture is discharged from the spent caustic with the sulphides after the conversion step and passed through one or more catalytic converters to break down unconverted ozone and/or to further oxidize compounds containing sulphur, especially hydrogen sulphide.

11. Method according to claim 1, characterised in that the spent caustic is caustic soda.

12. Method according to claim 1, characterised in that the non-sulphide-bearing, inorganic sulphur compounds are essentially sulphates.

13. Device for carrying out the method as per the invention with a feeder tank for sulphide-containing spent caustic and a reaction chamber connected in terms of flow with the feeder tank, wherein the reaction chamber includes at least one acoustic power converter and a mechanical cavitation element and wherein a supply unit for gas containing ozone is provided in the reaction chamber, characterised in that the device further includes one or more temperature sensors and a control unit connected to the temperature sensor(s) and the supply unit for controlling the quantity of gas containing ozone that is supplied to the reaction chamber in dependence upon the temperature of the spent caustic.
